(19) United States
(12) Patent Application Publication
(10) Pub. No.: US 2026/0237860 A1
(43) Pub. Date: Aug. 13, 2026

(54) BATTERY PACK INTERCONNECT ASSEMBLY FOR A BATTERY PACK

(71) Applicant: TE Connectivity Solutions GmbH, Schaffhausen (CH)

(72) Inventors: Evan DAWLEY, Troy, MI (US); Andre Martin DRESSEL, Bensheim (DE)

(21) Appl. No.: 19/410,344

(22) Filed: Dec. 5, 2025

Related U.S. Application Data
(60) Provisional application No. 63/757,657, filed on Feb. 12, 2025.

(51) Int. Cl. H01M 50/503; H01M 50/209; H01M 50/507; H01M 50/528

(52) U.S. Cl. CPC H01M 50/503; H01M 50/507; H01M 50/528; H01M 50/209

(57) ABSTRACT

A cell bussing web for forming a busbar interconnect for electrically connecting cell terminals of battery cells in a battery pack includes a metal sheet extending between first and second sides and having slots forming adjacent busbars in the metal sheet. The busbars. The metal sheet includes sacrificial connecting tabs spanning across the slots between the corresponding adjacent busbars to hold relative positions of the busbars in the matrix. Each busbar includes mating ends for mating with the corresponding cell terminals of the corresponding battery cells to electrically connect the battery cells in the battery pack. The sacrificial connecting tabs are configured to be removed to singulate the busbars and electrically separate the adjacent busbars from each other.

### CROSS REFERENCE TO RELATED APPLICATIONS

This application claims priority to U.S. Application No. 63/757,657, filed 12 Feb. 2025, subject matter of which is herein incorporated by reference in its entirety.

### BACKGROUND OF THE INVENTION

The subject matter herein relates generally to battery packs, such as battery packs for electric vehicles.

Electric vehicles include a battery system including a battery pack having a large number of battery cells. A typical battery system requires a connectivity solution to transfer/distribute power between groups of battery cells and have provisions for sensing battery parameters like voltage and temperature. To transfer power, busbars (aluminum or copper) are usually welded to the cell terminals in serial and/or parallel electrical configuration. As electric vehicle applications proliferate, the overhead cost of components ($/kWh) is scrutinized and there is a desire to minimize costs, such as by minimizing the part count and part numbers. For battery systems of electric vehicles, the battery cell stack sizes are very large. Typically, assembly of the battery system requires many parts, which are individually assembled to the corresponding cell terminals, which is time consuming and adds cost to the assembly process. For example, individual busbars may be separately assembled and welded to the corresponding cell terminals, which is time consuming and increases the cost of assembly.

A need remains for a method for assembling battery packs, such as for electric vehicles, in a cost effective and reliable manner.

### BRIEF DESCRIPTION OF THE INVENTION

In an embodiment, a cell bussing web for forming a busbar interconnect for electrically connecting cell terminals of battery cells in a battery pack is provided. The cell bussing web includes a metal sheet extending between a first side and a second side. The metal sheet includes slots forming adjacent busbars in the metal sheet. The metal sheet includes sacrificial connecting tabs spanning across the slots between the corresponding adjacent busbars to hold relative positions of the busbars in the matrix. Each busbar includes a first mating end for mating with the corresponding cell terminal of the corresponding battery cell and a second mating end for mating with the adjacent cell terminal of the adjacent corresponding battery cell. The busbars are configured to electrically connect the battery cells in the battery pack. The sacrificial connecting tabs are configured to be removed to singulate the busbars and electrically separate the adjacent busbars from each other.

In another embodiment, a battery pack interconnect assembly for electrically connecting cell terminals of battery cells in a battery pack is provided. The battery pack interconnect assembly includes a busbar interconnect that includes a plurality of busbars and a busbar carrier holding the busbars. Each busbar includes a first mating end for mating with the corresponding cell terminal of the corresponding battery cell and a second mating end for mating with the adjacent cell terminal of the adjacent corresponding battery cell. The busbars are configured to electrically connect the battery cells in the battery pack. The busbars are arranged in a cell bussing web. The cell bussing web includes slots between the adjacent busbars in the cell bussing web. The cell bussing web includes sacrificial connecting tabs spanning across the slots between the corresponding adjacent busbars to hold relative positions of the busbars.

In a further embodiment, a method of forming a cell bussing web for electrically connecting cell terminals of battery cells in a battery pack is provided. The method provides a metal sheet that includes a first side and a second side opposite the first side. The method cuts slots in the metal sheet to define corresponding busbars. The busbars are arranged in one or more rows and one or more columns with the slots therebetween, wherein sacrificial connecting tabs span across the slots between the corresponding adjacent busbars to hold relative positions of the busbars. The method applies an insulation film over the metal sheet. The insulation film spans the slots to hold the busbars relative to each other. The method removes the sacrificial connecting tabs to singulate and electrically separate the adjacent busbars from each other.

### BRIEF DESCRIPTION OF THE DRAWINGS

FIG. 1 is a perspective view of a battery pack including a battery pack interconnect assembly in accordance with an exemplary embodiment.

FIG. 2 is a top view of the battery pack interconnect assembly in accordance with an exemplary embodiment.

FIG. 3 illustrates a stack of the battery cells in accordance with an exemplary embodiment. FIG. 4 illustrates a cell bussing web for connecting to the stack of battery cells shown in FIG. 3 in accordance with an exemplary embodiment.

FIG. 5 illustrates the cell bussing web 150 in accordance with an exemplary embodiment.

FIG. 6 is an enlarged view of a portion of the cell bussing web shown in FIG. 5 in accordance with an exemplary embodiment.

FIG. 7 illustrates the cell bussing web in accordance with an exemplary embodiment showing the insulation film surrounding the metal sheet.

FIG. 8 illustrates the cell bussing web in accordance with an exemplary embodiment showing the insulation film and the metal sheet after removal of the sacrificial connecting tabs.

FIG. 9 illustrates a manufacture process for the cell bussing web in accordance with an exemplary embodiment.

FIG. 10 illustrates a manufacture process for the cell bussing web in accordance with an exemplary embodiment.

### DETAILED DESCRIPTION OF THE INVENTION

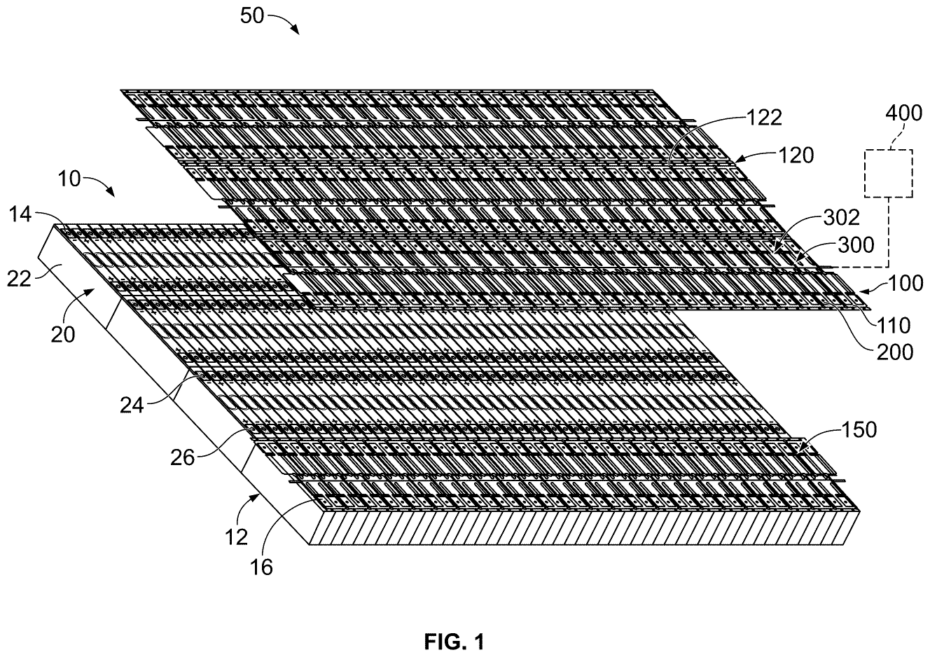

FIG. 1 is a perspective view of a battery pack 10 including a battery pack interconnect assembly 50 in accordance with an exemplary embodiment. The battery pack interconnect assembly 50 includes a busbar interconnect 100 including one or more cell bussing webs 150 for electrically connecting to the battery pack 10. The busbar interconnect 100 includes a plurality of busbars 200 and a sensing harness 300 for sensing parameters of the battery pack, such as voltage, temperature, charge state, or other operating characteristics of the battery pack 10. Each cell bussing web 150 includes a plurality of the busbars 200 arranged in one or more rows and one or more columns.

The battery pack 10 may be a battery pack for a vehicle, such as an electric vehicle. However, the battery pack 10 may be used in other applications in alternative embodiments. In an exemplary embodiment, the battery pack 10 is a high voltage battery pack. For example, the battery pack 10 may be a 400V or 800V battery pack. The busbar interconnect 100 is used to electrically connect a matrix of battery cells 20 of the battery pack 10. For example, the busbar interconnect 100 may electrically connect the battery cells 20 in series and/or parallel.

The battery cells 20 may be held in a battery pack housing 12. The battery pack 10 includes a positive battery interconnect terminal 14 and a negative battery interconnect terminal 16. The battery interconnect terminals 14, 16 may interface to other power distribution components of the battery pack 10, such as contactors and fuses for connection to a charging system and/or a load, such as an electric motor.

Each battery cell 20 includes a cell housing 22, a first cell terminal 24, and a second cell terminal 26. The battery cell 20 may be a prismatic battery cell in various embodiments. The first and second cell terminals 24, 26 may be cathode and anode terminals. In an exemplary embodiment, the battery cell 20 are rectangular and arranged in a stacked configuration. For example, the battery cells 20 may be stacked in rows and columns of battery cells 20 in the matrix. In an exemplary embodiment, each cell bussing web 150 may be coupled to a respective row or column of the stack of battery cells 20. The cell bussing webs 150 may be arranged side by side with associated rows or columns of the stacks of battery cells 20. In other various embodiments, each cell bussing web 150 may be associated with multiple rows or columns of the stacks of the battery cells 20. The cell matrix may have a large surface area, such as greater than two square meters (2 m² or more). For example, the matrix may have a length of between approximately 1.0 m and 2.0 m and a width of between approximately 1.0 m and 1.5 m. Adjacent battery cells 20 in the rows are interconnected by the corresponding busbars 200 of the busbar interconnect 100. Adjacent rows of the battery cells 20 are interconnected by the corresponding busbars 200 of the busbar interconnect 100. For example, end battery cells 20 may be connected row-to-row.

The busbar interconnect 100 includes a busbar carrier 110 holding the cell bussing web(s) 150 and the associated busbars 200. The busbar carrier 110 holds the cell bussing webs 150 and the busbars 200 at relative locations for mating with the cell terminals 24, 26 of the corresponding battery cells 20. The busbars 200 electrically connect adjacent battery cells 20, such as in series and/or in parallel. In various embodiments, the busbar carrier 110 integrates all of the cell bussing webs 150 and the busbars 200 into a single unit or structure for mounting to the matrix of battery cells 20. For example, a single busbar carrier 110 may be used to hold all of the busbars 200. In other various embodiments, the busbar carrier 110 may include multiple frames or units, each holding a plurality of the busbars 200, such as a column of the busbars 200, the frames/units may be connected together by other elements of the busbar carrier 110 to form a connected structure. For example, each cell bussing web 150 may have an associated busbar carrier 110 and the busbar carriers 110 may be coupled together to position the cell bussing webs 150 over the corresponding stacks of the battery cells 20.

In various embodiments, the busbar carrier 110 may be a molded plastic structure, a structural foam leadframe, a laminated film, or other structural component configured to hold the busbars 200. The busbar carrier 110 may be formed in place over the cell bussing web 150 and the corresponding busbars 200. For example, the busbar carrier 110 may be molded or formed on the cell bussing web 150. For example, the busbar carrier 110 may be overmolded in situ over portions of the busbars 200 to form the busbar interconnect 100. In other embodiments, the busbar carrier 110 is laminated over the cell bussing web 150. The busbar carrier 110 may be formed around portions of the cell bussing web 150 to hold the busbars 200 relative to each other and relative to the cell terminals 24, 26 of the battery cells 20.

In an exemplary embodiment, the busbar carrier 110 may include a framework or lattice 120 formed around portions of the busbars 200 to hold the busbars 200 at relative positions. In an exemplary embodiment, the busbar carrier 110 holds all of the busbars 200 of each cell bussing web 150 and/or for the battery pack 10 to reduce part count for final assembly to the battery pack 10. For example, a single busbar interconnect 100 may be assembled to the battery pack 10. The busbar carrier 110 is used to position the busbars 200 for electrical connection to the cell terminals 24, 26 of the battery cells 20. In an exemplary embodiment, the sensing harness 300 is coupled to the busbar carrier 110. The busbar carrier 110 may be used to position the sensing harness on the battery cells 20.

In an exemplary embodiment, the sensing harness 300 has sensing points 302 for monitoring the busbars 200 and/or the cell terminals 24, 26. For example, the sensing harness 300 is electrically connected to the busbars 200 at the sensing points 302 to monitor voltage, temperature, charge state, or other operating characteristics of the busbars 200 and/or the cell terminals 24, 26. The sensing harness 300 is configured to be electrically connected to a control module 400, such as a battery control module. The sensing harness 300 sends sensing signals from the sensing points 302 to the control module 400, which may be used to control operation of the vehicle and/or a charging operation of the vehicle.

The battery pack interconnect assembly 50 provides a large format battery cell interconnect assembly that is configured to be mounted to the battery pack 10 (for example, each of the battery cells 20) as a single unit. The busbar carrier 110 holds the busbars 200 at proper locations for termination to the cell terminals 24, 26 of each of the battery cells 20 of the battery pack 10. By holding all of the busbars 200 of the cell bussing web(s) 150 for assembly to the corresponding battery cells 20, assembly processes may be eliminated, such as with conventional battery systems where each of the busbars are assembled to the battery cells individually with multiple assembly steps. The busbar interconnect 100 reduces the overall part number count and reduces the number of handled components during assembly of the battery pack 10. The busbar carrier 110 may have a large format and surface area. For example, the structural process to manufacture the lattice framework for the busbar carrier 110 enables a large footprint for the busbar carrier 110. The structural material of the lattice framework for the busbar carrier 110 is dimensionally stable and does not tend to warp making assembly and termination to the battery cells more simple, quicker, and lower cost compared to conventional assembly processes.

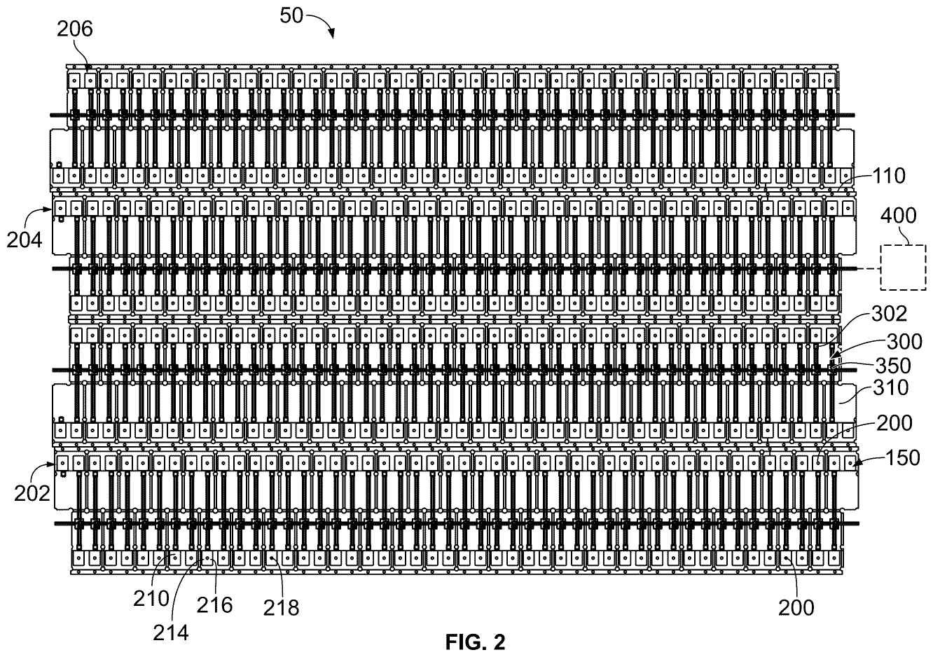

FIG. 2 is a top view of the battery pack interconnect assembly 50 in accordance with an exemplary embodiment. FIG. 2 illustrates the cell bussing webs 150 forming a matrix 202 of the busbars 200 and the sensing harness 300 coupled to the busbars 200. The busbars 200 are arranged in rows 204 and columns 206 in the matrix 202. In an exemplary embodiment, each cell bussing web 150 forms one or more strips of the busbars 200, such as one or more of the columns 206 of the busbars 200. Each cell bussing web 150 may include multiple rows of the busbars 200.

The arrangement of the busbars 200 corresponds to the arrangement of the battery cells 20 to connect to the corresponding cell terminals 24, 26. The sensing harness 300 traverses the rows 204 and columns 206 of the busbars 200 to electrically connect to each of the busbars 200 for sensing characteristics (for example, voltages) of each of the busbars 200.

Each busbar 200 includes a metal plate 210 having a main body including a first mating pad 214 at a first end and a second mating pad 216 at a second end. The first mating pad 214 is configured to connect to a cell terminal 24 of one of the battery cells 20. The second mating pad 216 is configured to connect to a cell terminal 26 of an adjacent battery cell 20. The busbar 200 electrically connects the adjacent battery cells 20. The mating pads 214, 216 may include openings 218 therethrough, such as for locating the busbars 200 relative to the cell terminals 24, 26. The openings 218 may be used for a pick and place operation. The openings 218 may be used to hold positions of the busbars 200 during the overmolding process of forming the busbar carrier 110.

In an exemplary embodiment, each busbar 200 is generally rectangular. For example, the busbar 200 includes a first end, a second end, a first side, and a second side. The busbar 200 may be elongated, such as having the ends longer than the sides. In an exemplary embodiment, the busbar 200 is generally planar. For example, the first and second mating pads 214, 216 may be coplanar for attachment to the cell terminals 24, 26. Optionally, the main body may be offset or out of plane relative to the first and second mating pads 214, 216, such as located above or below the plane of the first and second mating pads 214, 216. The busbar 200 may include mounting features, such as mounting tabs, posts, brackets, clips, notches, openings, and the like for mounting the busbar 200 to the busbar carrier 110.

In an exemplary embodiment, the matrix 202 of the busbars 200 include eight rows 204 of the busbars 200 and twenty-five columns 206 of the busbars 200. Greater or fewer busbars 200 may be provided in the rows 204 and/or the columns 206 in alternative embodiments. In an exemplary embodiment, each cell bussing web 150 includes two rows 204 of the busbars 200 with twenty-five columns 206 of the busbars 200. Greater or fewer busbars 200 may be provided in the rows 204 and/or the columns 206 in alternative embodiments. In an exemplary embodiment, the matrix includes four of the cell bussing webs 150 arranged side-by-side to connect to the various columns of the battery cells. Greater or fewer of the cell bussing webs 150 may be provided in alternative embodiments.

The sensing harness 300 includes busbar sensing cables 310 having sensing circuits 312 configured to be coupled to the corresponding busbars 200. In an exemplary embodiment, the busbar sensing cables 310 include flexible circuits 320 including the sensing circuits 312 and conductors extending from the sensing circuits 312, such as to the control module 400. The flexible circuits 320 may be flat flexible cables or flexible printed circuits. The sensing harness 300 may include connecting cables (not shown) coupled to each of the busbar sensing cables 310 to aggregate signals for the sensing harness 300. For example, the busbar sensing cables 310 and the connecting cables may form a lattice structure that overlaps the matrix 202 of the busbars 200. The connecting cables may be flexible circuits, such as flat flexible cables or flexible printed circuits. The busbar sensing cables 310 and the connecting cables may be oriented perpendicular to each other. The busbar sensing cables 310 may be flexible circuits, such as flat flexible cables or flexible printed circuits. The connecting cables may be flexible circuits, such as flat flexible cables or flexible printed circuits.

In an exemplary embodiment, the busbar sensing cables 310 extend along the rows 204 of the busbars 200 and are electrically connected to each of the busbars 200 in the corresponding row 204 at the corresponding sensing points 302 to sense characteristics, such as voltage, of each of the corresponding busbars 200. The connecting cables span each of the busbar sensing cables 310 and are electrically connected to the busbar sensing cables 310 to aggregate the signals from the busbar sensing cables 310. The busbar sensing cables 310 and/or the connecting cables may be electrically connected to the control module 400.

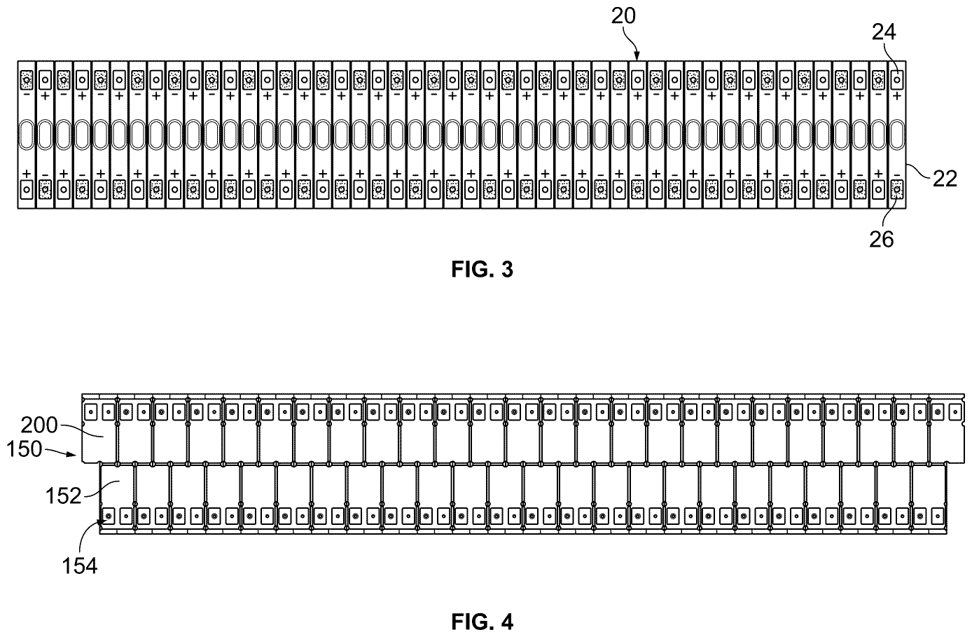

FIG. 3 illustrates a stack of the battery cells 20 and FIG. 4 illustrates a cell bussing web 150 for connecting to the stack of battery cells 20 shown in FIG. 3. Each battery cell 20 includes the cell housing 22, the first cell terminal 24, and the second cell terminal 26. The battery cells 20 are rectangular arranged in a stacked configuration (for example, a cell column). The cell bussing web 150 (FIG. 4) is configured to be coupled to the stack of battery cells 20. Adjacent battery cells 20 are configured to be interconnected by the corresponding busbars 200 of the cell bussing web 150.

In an exemplary embodiment, the cell bussing web 150 includes an insulation film 152 surrounding the busbars 200 of the cell bussing web 150. The insulation film 152 may form at least part of the busbar carrier 110. For example, the insulation film 152 may hold relative positions of the busbars 200 within the cell bussing web 150. In an exemplary embodiment, the insulation film 152 includes windows 154 exposing portions of the busbars 200, such as portions of the busbars 200 configured to be terminated (for example, welded) to the cell terminals 24, 26 of the battery cells 20. In various embodiments, the sensing harness 300 may be terminated to the busbars 200 at the exposed portions through the windows 154.

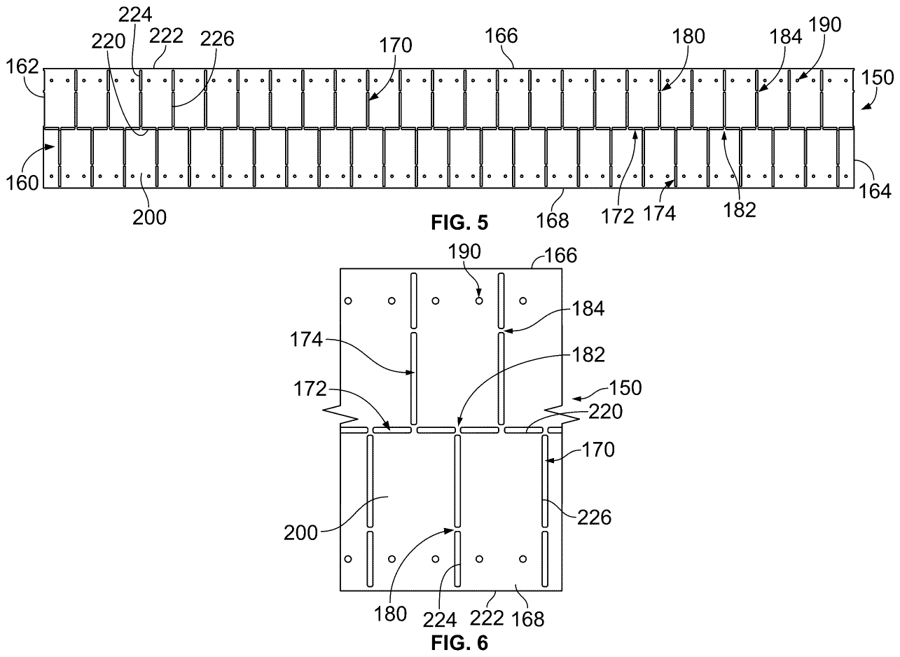

FIG. 5 illustrates the cell bussing web 150 in accordance with an exemplary embodiment. FIG. 6 is an enlarged view of a portion of the cell bussing web 150 shown in FIG. 5. In an exemplary embodiment, the cell bussing web 150 includes a metal sheet 160 that forms the busbars 200. A plurality of the busbars 200 are formed from the metal sheet 160. In an exemplary embodiment, each busbar 200 is generally rectangular. For example, each busbar 200 includes the first end 220, the second end 222, the first side 224, and the second side 226.

In an exemplary embodiment, the metal sheet 160 may be formed from a metal coil or reel that is unwound and processed to form the busbars 200. For example, the metal sheet 160 may be fed from a continuous coil and cut to length corresponding to the length of the stack of the battery cells 20. The busbars 200 may be individually separated from the metal sheet 160 to electrically connect the corresponding battery cells 20.

The metal sheet 160 has a length extending between a first end 162 and a second end 164. The metal sheet 160 has a width extending between a first side 166 and a second side 168. The metal sheet 160 extends longitudinally, lengthwise between the first and second ends 162, 164. The metal sheet 160 extends laterally between the first and second sides 166, 168. In an exemplary embodiment, the metal sheet 160 includes a plurality of the busbars 200 arranged longitudinally between the first and second ends 162, 164. For example, in the illustrated embodiment, the metal sheet 160 includes approximately forty-nine busbars 200 between the first and second ends 162, 164 arranged in two rows. The metal sheet 160 may include greater or fewer busbars 200 in alternative embodiments. In an exemplary embodiment, the metal sheet includes a plurality of the busbars 200 arranged laterally (for example, side to side) between the first and second sides 166, 168. For example, in the illustrated embodiment, the metal sheet 160 includes two rows of the busbars 200 between the first and second sides 166, 168. The busbars 200 at the first side 166 are configured to interface with the cell terminals 24, 26 at first sides of the battery cells 20 and the busbars 200 at the second side 168 are configured to interface with the cell terminals 24, 26 at second sides of the battery cells 20.

In an exemplary embodiment, the metal sheet 160 includes slots 170 through the metal sheet 160. The slots 170 separate the busbars 200 from one another. In an exemplary embodiment, the slots 170 are formed by a cutting process, such as a laser-based cutting process (for example, laser blanking). The slots 170 may be cut in the metal sheet 160 as a metal sheet 160 is unwound from the reel. The slots 170 separate the busbars 200 in the rows from each other and the slots 170 separate the busbars 200 in the columns from each other.

In an exemplary embodiment, the slots 170 include longitudinal slots 172 extending longitudinally along the metal sheet 160, such as parallel to the first and second sides 166, 168. The longitudinal slots 172 are provided between the rows of the busbars 200. In the illustrated embodiment, the longitudinal slots 172 are centered along the metal sheet 160 between the first and second sides 166, 168. As such, the busbars 200 in the two rows have equal widths. However, the longitudinal slots 172 may be offset, such as closer to the first side 166 or closer to the second side 168 such that the busbars 200 have different widths.

In an exemplary embodiment, the slots 170 include lateral slots 174 extending laterally across the metal sheet 160, such as between the first and second sides 166, 168. The lateral slots 174 separate the columns of the busbars 200 from each other. In the illustrated embodiment, the lateral slots 174 on the opposite sides of the longitudinal slots 172 are offset from each other such that the busbars 200 in the adjacent rows are staggered relative to each other. However, in alternative embodiments, the lateral slots 174 on the opposite sides of the longitudinal slots 172 may be aligned with each other such that the busbars 200 in the adjacent rows are aligned with each other.

In an exemplary embodiment, the metal sheet 160 includes sacrificial connecting tabs 180 spanning across the slots 170 between the corresponding adjacent busbars 200 to hold relative positions of the busbars 200. The sacrificial connecting tabs 180 are configured to be removed at a later processing step, such as after the busbars 200 are held together by the busbar carrier 110, to singulate the busbars 200 from each other and thus electrically separate the adjacent busbars 200 from each other. The sacrificial connecting tabs 180 may be removed by a cutting process, such as a laser based cutting process. In an exemplary embodiment, the slots 170 do not extend the entire length of the metal sheet 160 or the entire width of the metal sheet 160. Rather, the slots 170 extend only partially along the length and the width of the metal sheet 160, leaving behind the sacrificial connecting tabs 180 to hold the relative positions of the busbars 200 and provide sufficient structural integrity for the metal sheet 160, such as for further processing and assembly.

In an exemplary embodiment, the sacrificial connecting tabs 180 include longitudinal connecting tabs 182 extending across the longitudinal slots 172. The longitudinal connecting tabs 182 connect the busbars 200 in the opposite rows. The longitudinal connecting tabs 182 may be provided at the corners of the busbars 200, such as at the first side 224 and the second side 226 of each busbar 200. The longitudinal connecting tabs 182 may be provided at a central location along the inner ends 220 of the busbars 200. Other locations are possible in alternative embodiments.

In an exemplary embodiment, the sacrificial connecting tabs 180 include lateral connecting tabs 184 extending across the lateral slots 174. For example, the lateral connecting tabs 184 may extend between the first side 224 of one of the busbars 200 and the second side 226 of the adjacent busbar 200. The lateral connecting tabs 184 connect the adjacent busbars 200 in each of the rows. The lateral connecting tabs 184 may be provided at the corners of the busbars 200, such as at the inner ends 220 and the outer ends 222 of each of the busbars 200. The lateral connecting tabs 184 may be provided at an intermediate location between the ends 220, 222, such as approximately centered between the ends 220, 222.

In an exemplary embodiment, the metal sheet 160 includes openings 190 in each of the busbars 200. Optionally, multiple openings 190 may be provided in each of the busbars 200. The openings 190 may be used for positioning the busbars 200 relative to the cell terminals 24, 26 of the battery cells 20. The openings 190 may be used for terminating to the cell terminals 24, 26, such as by a laser welding process. In the illustrated embodiment, the openings 190 are located proximate to the outer ends 222 of the busbars 200. Other locations are possible in alternative embodiments. The openings 190 may be formed by a laser cutting process (for example, laser blanking).

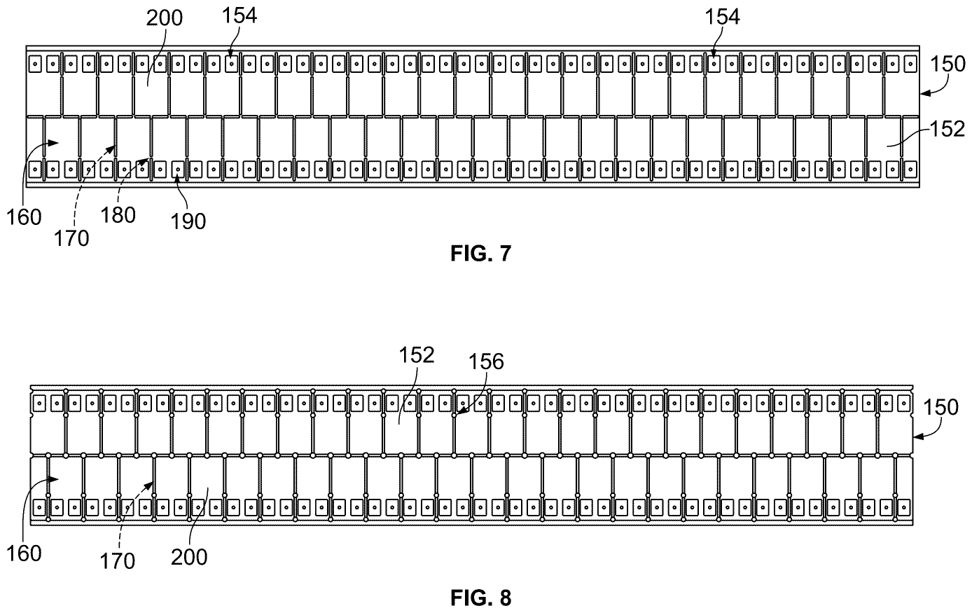

FIG. 7 illustrates the cell bussing web 150 in accordance with an exemplary embodiment showing the insulation film 152 surrounding the metal sheet 160. The insulation film 152 is applied to the metal sheet 160. In various embodiments, the insulation film 152 may be applied by a lamination process to cover the top surface and/or the bottom surface of the metal sheet 160. When applied, the insulation film 152 covers the sacrificial connecting tabs 180. The insulation film 152 spans the slots 170 and may support the busbars 200 relative to each other.

The insulation film 152 includes the windows 154 that expose portions of the metal sheet 160. In the illustrated embodiment, the windows 154 are aligned with the openings 190. The windows 154 expose portions of the busbars 200 for termination cell terminals 24, 26 of the battery cells 20, such as for laser welding the busbars 200 to the cell terminals 24, 26.

FIG. 8 illustrates the cell bussing web 150 in accordance with an exemplary embodiment showing the insulation film 152 and the metal sheet 160 after removal of the sacrificial connecting tabs 180. During manufacture, the sacrificial connecting tabs 180 are removed to singulate the busbars 200 from each other and thus electrically separate the adjacent busbars 200 from each other. The sacrificial connecting tabs 180 may be removed by a cutting process, such as a laser based cutting process. During the removal process, portions of the insulation film 152 are also removed. For example, the insulation film 152 may include openings 156 at the areas where the sacrificial connecting tabs 180 are removed. However, other portions of the insulation film 152 remain spanning across the slots 170 thus holding relative positions of the busbars 200 even after the sacrificial connecting tabs 180 are removed.

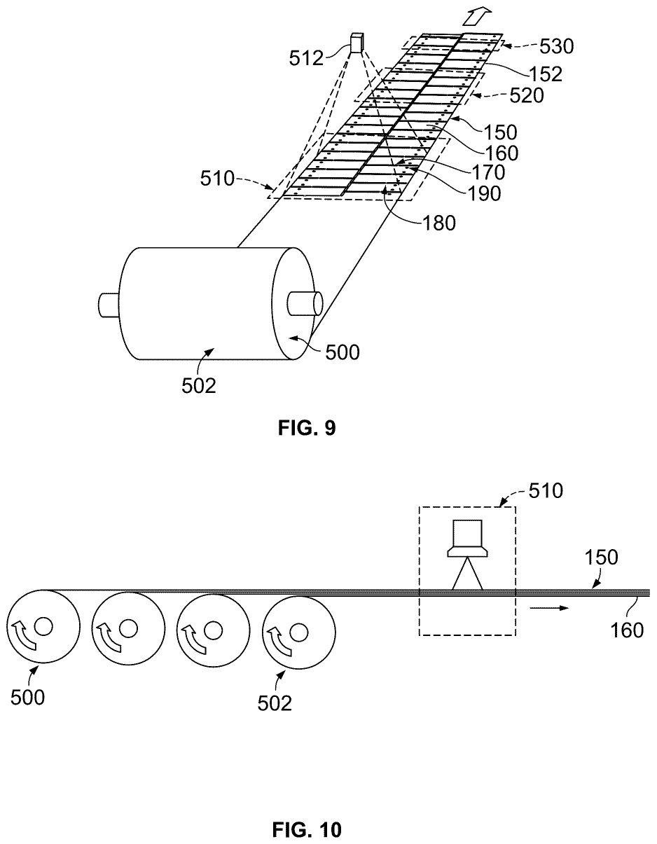

FIG. 9 illustrates a manufacture process for the cell bussing web 150 in accordance with an exemplary embodiment. The metal sheet 160 is initially arranged as a metal coil 500 on a reel 502. The metal sheet 160 is unwound from the reel 502 and may be continuously pulled through one or more processing stations. In an exemplary embodiment, the metal sheet 160 on the reel 502 has a width corresponding to the desired width of the cell bussing web 150, such as a width corresponding to the width of the battery cell 20.

In an exemplary embodiment, the metal sheet 160 is moved through a blanking station 510 where the slots 170 and the openings 190 are formed in the metal sheet 160. In an exemplary embodiment, one or more lasers 512 may be provided at the blanking station 510 for cutting these slots 170 and the openings 190 in the metal sheet 160. The lasers 512 may be configured to cut the slots 170 as the metal sheet 160 is continuously moved through the blanking station 510. In other embodiments, a predetermined length of the metal sheet 160 may be advanced to the blanking station 510 for processing. The metal sheet 160 may remain stationary during the processing at the blanking station 510 before advancing downstream and bringing a new portion of the metal sheet 160 to the blanking station 510.

In an exemplary embodiment, the metal sheet 160 is moved through a lamination station 520 where the insulation film 152 is applied to the metal sheet 160. In an exemplary embodiment, the continuous cell bussing web 150 may be moved through the lamination station 520. However, in alternative embodiments, the cell bussing web 150 may be cut to length, such as a length corresponding to the length of the stack of battery cells 20 to provide the metal sheet 160 cut to length. The individual metal sheets 160 may be fed to the lamination station 520 rather than being fed as part of the continuous cell bussing web 150.

In an exemplary embodiment, the metal sheet 160 is moved through a cutting station 530 where the sacrificial connecting tabs 180 are removed. The cutting station 530 may include one or more lasers for cutting the metal sheet 160 and removing the sacrificial connecting tabs 180. Other types of cutting processes may be performed at the cutting station 530 to remove the sacrificial connecting tabs 180.

The cell bussing web 150 may be advanced through other processing stations located upstream or downstream of any of the stations illustrated in FIG. 9.

FIG. 10 illustrates a manufacture process for the cell bussing web 150 in accordance with an exemplary embodiment. In the illustrated embodiment, the metal sheet 160 is a multilayer sheet. For example, a plurality of the metal coils 500 are provided on corresponding reels 502. The metal coils 500 are unwound and layered together to form the metal sheet 160. Adhesive layers may be provided between the stack of metal layers. The adhesive layers may be heated and/or compressed to form the metal sheet 160. The metal layers are stacked prior to advancing the metal sheet 160 through the blanking station 510.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. A cell bussing web for forming a busbar interconnect for electrically connecting cell terminals of battery cells in a battery pack, the cell bussing web comprising:
a metal sheet extending between a first side and a second side, the metal sheet including slots forming adjacent busbars in the metal sheet, the busbars being arranged, the metal sheet including sacrificial connecting tabs spanning across the slots between the corresponding adjacent busbars to hold relative positions of the busbars in the matrix;
wherein each busbar includes a first mating end for mating with the corresponding cell terminal of the corresponding battery cell and a second mating end for mating with the adjacent cell terminal of the adjacent corresponding battery cell, the busbars configured to electrically connect the battery cells in the battery pack
wherein the sacrificial connecting tabs are configured to be removed to singulate the busbars and electrically separate the adjacent busbars from each other.

2. The cell bussing web of claim 1, wherein the slots are formed by laser cutting the metal sheet.

3. The cell bussing web of claim 1, wherein the slots separate the busbars in rows from each other and the slots separate the busbars in columns from each other.

4. The cell bussing web of claim 1, wherein the metal sheet includes two rows of the busbars configured to be mated with the cell terminals at opposite ends of the corresponding battery cells.

5. The cell bussing web of claim 1, wherein each busbar includes a first side and a second side opposite the first side and wherein each busbar includes an inner end and an outer end opposite the inner end, the inner ends of the busbars facing inner ends of busbars in an adjacent row across the corresponding slots, the first sides facing second sides of the adjacent busbars in the same row across the corresponding slots.

6. The cell bussing web of claim 1, wherein the slots include longitudinal slots extending longitudinally along the metal sheet parallel to the first and second sides, and wherein the slots include lateral slots extending laterally across the metal sheet between the first and second sides.

7. The cell bussing web of claim 6, wherein the longitudinal slots separate rows of the busbars from each other, the lateral slots separating columns of the busbars from each other.

8. The cell bussing web of claim 6, wherein the lateral slots on opposite sides of the longitudinal slots are offset from each other such that the busbars in adjacent rows are staggered relative to each other.

9. The cell bussing web of claim 1, wherein the busbars include openings proximate to the first side or the second side of the metal sheet.

10. The cell bussing web of claim 1, wherein the metal sheet is unrolled from a reel of metal.

11. The cell bussing web of claim 1, wherein the metal sheet is a layered structure having multiple metal layers.

12. The cell bussing web of claim 11, wherein the metal layers are joined by adhesive layers.

13. The cell bussing web of claim 1, further comprising an insulation film surrounding the metal sheet, the insulation film including windows exposing portions of the busbars, the insulation film spanning the slots to hold relative positions of the busbars.

14. The cell bussing web of claim 13, wherein portions of the insulation film is removed to remove the sacrificial connecting tabs.

15. A battery pack interconnect assembly for electrically connecting cell terminals of battery cells in a battery pack, the battery pack interconnect assembly comprising:
a busbar interconnect including a plurality of busbars and a busbar carrier holding the busbars;
each busbar including a first mating end for mating with the corresponding cell terminal of the corresponding battery cell and a second mating end for mating with the adjacent cell terminal of the adjacent corresponding battery cell, the busbars configured to electrically connect the battery cells in the battery pack;
wherein the busbars are arranged in a cell bussing web, the cell bussing web including slots between the adjacent busbars in the cell bussing web, the cell bussing web including sacrificial connecting tabs spanning across the slots between the corresponding adjacent busbars to hold relative positions of the busbars.

16. A method of forming a cell bussing web for electrically connecting cell terminals of battery cells in a battery pack, the method comprising:
providing a metal sheet including a first side and a second side opposite the first side;
cutting slots in the metal sheet to define corresponding busbars, the busbars being arranged in one or more rows and the busbars being arranged in one or more columns with the slots therebetween, wherein sacrificial connecting tabs span across the slots between the corresponding adjacent busbars to hold relative positions of the busbars;
applying an insulation film over the metal sheet, the insulation film spanning the slots to hold the busbars relative to each other; and
removing the sacrificial connecting tabs to singulate and electrically separate the adjacent busbars from each other.

17. The method of claim 16, wherein the slots are cut into the metal sheet using a laser based cutting process.

18. The method of claim 16, wherein said providing the metal sheet includes unrolling the metal sheet from a reel of metal.

19. The method of claim 16, wherein said removing the sacrificial connecting tabs includes using a laser based cutting process.

20. The method of claim 16, wherein said providing a metal sheet includes unrolling multiple layers of metal foils from metal reels and stacking the layers of metal foils into the metal sheet.
